(19) United States
(12) Patent Application Publication
(10) Pub. No.: US 2012/0074126 A1
(43) Pub. Date: Mar. 29, 2012

(54) WAFER PROFILE MODIFICATION THROUGH HOT/COLD TEMPERATURE ZONES ON PEDESTAL FOR SEMICONDUCTOR MANUFACTURING EQUIPMENT

(75) Inventors: Won B. Bang, Gilroy, CA (US); Tien Fak Tan, Fremont, CA (US); Son M. Phi, Milpitas, CA (US); Dmitry Lubomirsky, Cupertino, CA (US)

(73) Assignee: Applied Materials, Inc., Santa Clara, CA (US)

(21) Appl. No.: 13/072,546

(22) Filed: Mar. 25, 2011

Related U.S. Application Data
(60) Provisional application No. 61/318,108, filed on Mar. 26, 2010.

(51) Int. Cl. H05B 3/68

(52) U.S. Cl. 219/443.1

(57) ABSTRACT

A substrate support comprising a top ceramic plate providing a substrate support surface for supporting a substrate during substrate processing, a substrate pedestal having coolant channels formed therein and a thermoelectric deck sandwiched between the top ceramic plate and substrate pedestal. The thermoelectric deck includes a plurality of embedded thermoelectric elements that can either heat or cool the substrate support surface.

### CROSS-REFERENCES TO RELATED APPLICATIONS

This application claims the benefit of U.S. Provisional Patent Application No. 61/318,108, filed Mar. 26, 2010, which is incorporated herein by reference for all purposes.

### BACKGROUND OF THE INVENTION

The present invention relates generally to the field of substrate processing equipment. More specifically, the present invention relates to an apparatus and method for controlling the temperature of substrates, such as semiconductor substrates, used in the manufacture of integrated circuits.

Modern integrated circuits (ICs) contain millions of individual elements that are formed by patterning the materials, such as silicon, metal and/or dielectric layers, that make up the integrated circuit to sizes that are small fractions of a micrometer. Many of the steps associated with the fabrication of integrated circuits include precisely controlling the temperature of the semiconductor substrate upon which the ICs are formed.

One challenge semiconductor manufacturers face in such process steps is controlling the temperature of the substrate uniformly across the entire surface of the substrate. Even minor differences in temperature between various locations of the substrate may result in undesirable differences in physical characteristics of one or more of the layers formed at those locations on the substrate. Towards this end, substrate heaters have been developed that include multiple heater elements arranged in different zones. Such an arrangement allows one zone of the heater to be heated at a different temperature than other zones to compensate for temperature nonuniformities that may occur between different points on the semiconductor substrate.

FIG. 1 is a top plan view of an example of a previously known substrate heater that includes six different electrically independently heating zones. As shown in FIG. 1, substrate heater 10 includes six independent heater zones 12₁-12₆ along with a corresponding number of temperature sensors 14₁-14₆, one for each of the heater zones. Separate resistive heaters (not shown) operate in each of the heater zones.

While the substrate heater shown in FIG. 1 is useful for many substrate processing operations, new and improved methods and substrate supports for accurately controlling substrate temperature are desired.

### BRIEF SUMMARY OF THE INVENTION

Embodiments of the invention provide a substrate support having a top ceramic plate that provides a substrate support surface for supporting a substrate during substrate processing; a substrate pedestal having coolant channels formed therein; and a thermoelectric deck sandwiched between the top ceramic plate and substrate pedestal that includes a plurality of thermoelectric elements embedded therein. The thermoelectric deck within the substrate support allows for the control temperature variations across the substrate support surface at a very high resolution (e.g., 0.2-0.3 degrees Celsius).

A substrate support according to one embodiment of the invention comprises a top ceramic plate that provides a substrate support surface to support a substrate during substrate processing, a substrate pedestal having fluid channels formed therein, and a thermoelectric deck sandwiched between the top ceramic plate and substrate pedestal. The fluid channels provide a first temperature control mechanism and the thermoelectric deck can include a plurality of thermoelectric elements embedded therein that provide a second temperature control mechanism and can either heat or cool the substrate support surface.

In another embodiment a substrate support according to the present invention comprises a top ceramic plate having a substrate support surface for supporting a substrate during substrate processing, a substrate pedestal having fluid channels formed therein and adapted to circulate a heat transfer fluid through the pedestal, and a thermoelectric deck sandwiched between the top ceramic plate and substrate pedestal. The thermoelectric deck includes a base plate, a deck cover, and a plurality of thermoelectric elements positioned between the base plate and the deck cover arranged in at least two independently controlled temperature zones. Each of the independently controlled temperature zones includes a temperature sensor. In response to readings from the temperature sensor associated with a particular temperature zone, temperature within the zone can be increased or decreased to heat or cool the substrate support surface in that zone independent of the other zones. From an overall system perspective, a heat transfer fluid can be circulated through the fluid control channels as the primary mechanism to control the temperature of the substrate support surface (and thus primary mechanism to control substrate temperature). The independently controlled temperature zones of the thermoelectric deck allow for more precise temperature adjustments across the substrate support surface at a resolution and rate that cannot otherwise be achieved by circulation of the fluid heat transfer medium alone.

Various benefits and advantages that can be achieved by the present invention are described in detail below in conjunction with the following drawings.

### BRIEF DESCRIPTION OF THE DRAWINGS

FIG. 1 is a simplified representative view of a previously known substrate heater;

FIG. 2 is a simplified perspective view of a substrate support according to one embodiment of the present invention;

FIG. 3 is a simplified cross-sectional view of the substrate support shown in FIG. 2;

FIG. 4 is a simplified diagram depicting a two temperature zone controlled substrate support according to one embodiment of the present invention;

FIG. 5 is a simplified diagram depicting a four temperature zone controlled substrate support according to another embodiment of the present invention;

FIG. 6 is a simplified cross-sectional view of a portion of the substrate support shown in FIG. 2 depicting a thermoelectric chip embedded within the substrate support;

FIG. 7 is a simplified perspective view of thermoelectric deck cover 24 shown in FIG. 3; and

FIGS. 8 and 9 are simplified top and bottom perspective views, respectively, of thermoelectric deck base 22 shown in FIG. 3.

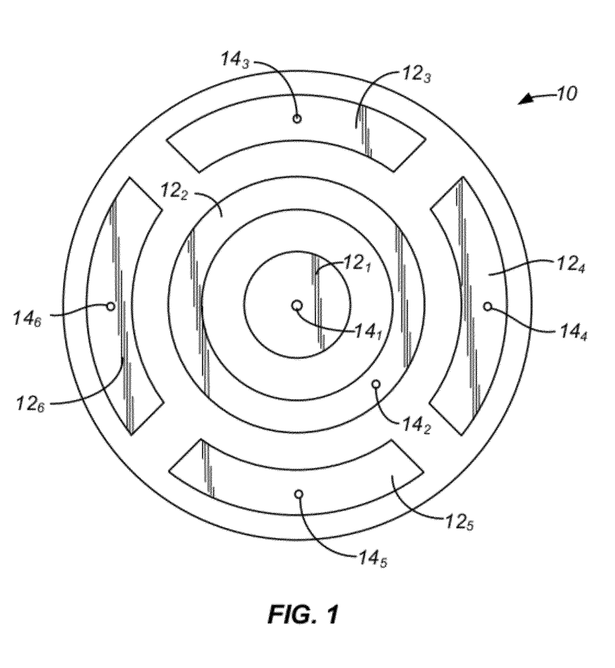

### DETAILED DESCRIPTION OF THE INVENTION

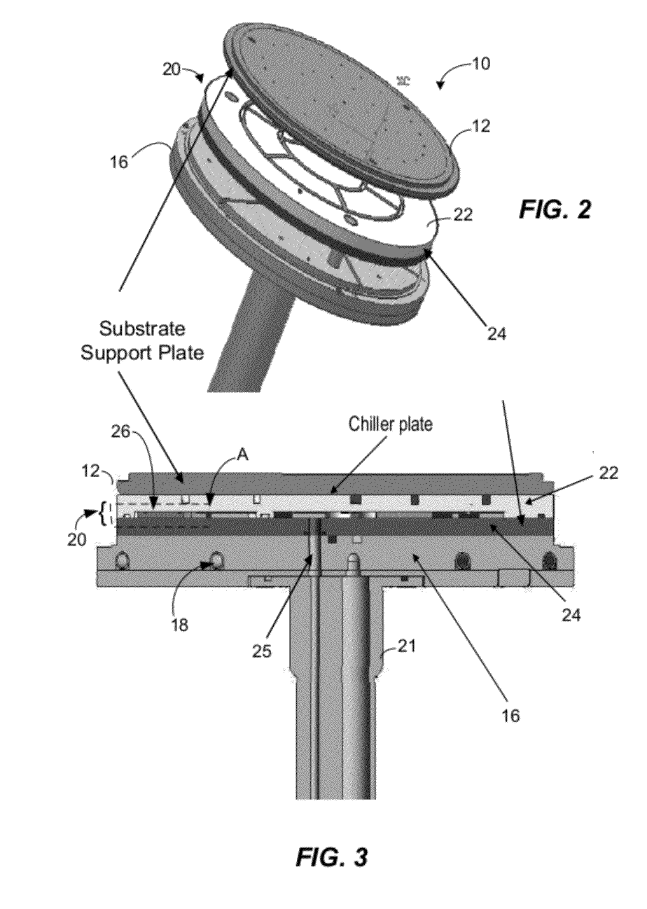

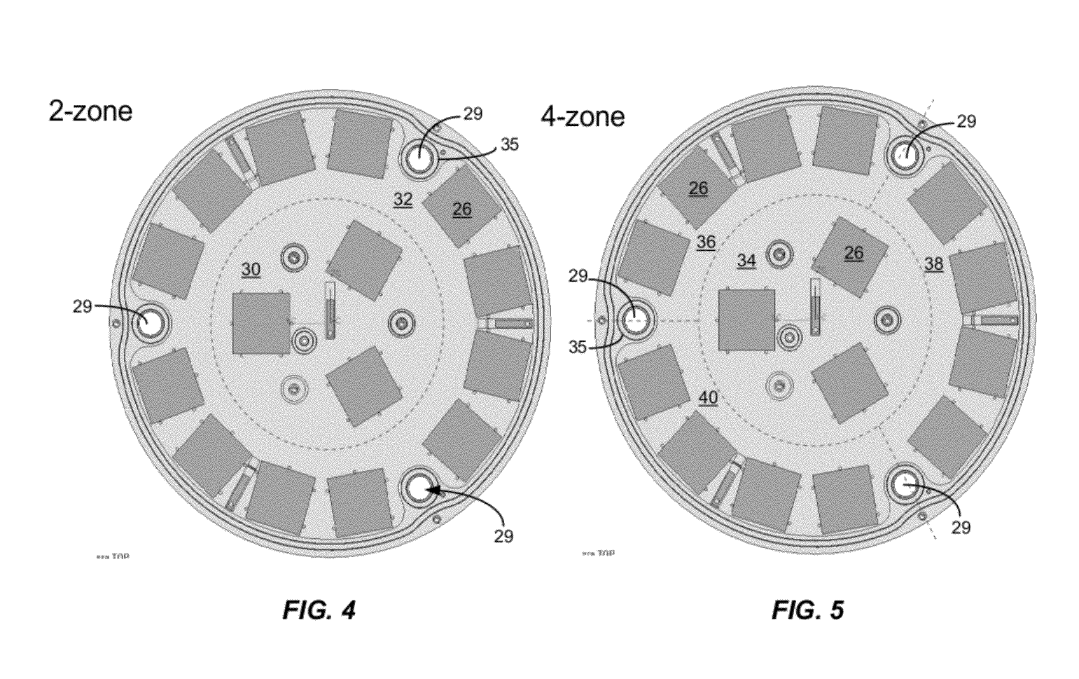

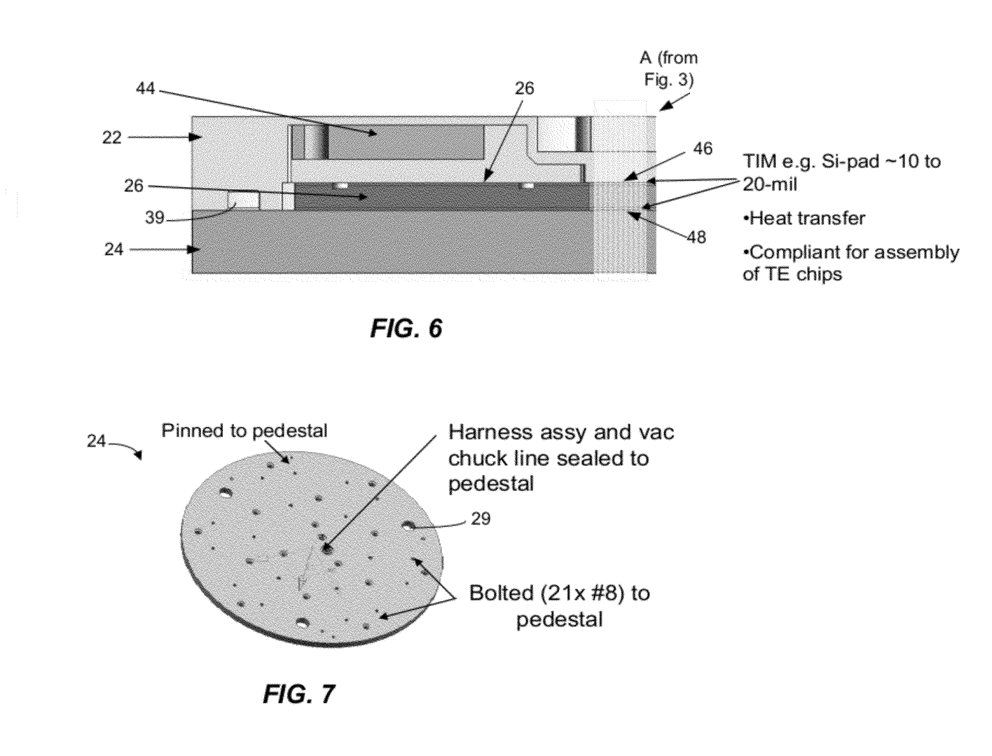

Reference is made to FIGS. 2 and 3 which represent a simplified perspective view of a substrate support 10 and a simplified cross-sectional view of substrate support 10, respectively, according to one embodiment of the present invention. Substrate support 10 can be positioned within a substrate processing chamber (not shown) that includes gas delivery, pressure control and temperature control systems, among others, to carry out film deposition, film etching and other processes on a substrate positioned on the substrate support. Substrate support 10 includes a top plate 12 that provides a substrate support surface 14 for supporting a substrate during such substrate processing operations; a substrate pedestal 16 having fluid channels 18 (shown in FIG. 3) formed therein; and a thermoelectric deck 20 sandwiched between the top ceramic plate and substrate pedestal.

As a primary temperature control mechanism for substrate support 10, a fluid heat transfer medium (e.g., a coolant) can be circulated through channels 18 to control the temperature of substrate support 10 and thus control the temperature of a substrate positioned on surface 10 during a substrate processing operation. The heat transfer medium may heat or cool the substrate support surface as desired depending on the process performed in the substrate processing chamber. Exemplary heat transfer fluids include liquids such as water, ethylene glycol, or a mixture thereof as well as gases such as nitrogen. The fluid heat transfer medium is delivered to channels 18 via coolant lines that run through a stem 21 of pedestal 16 to a heat exchanger (not shown) as is known to those of skill in the art.

Top plate 12 provides an insulation layer between the substrate and thermoelectric deck to dull temperature differences across the substrate support. In one embodiment, plate 12 is made from a ceramic, such as an aluminum oxide. Thermoelectric deck 20 includes a base plate 22 and a thermoelectric deck cover 24 each of which can be made from a conductive aluminum alloy or a similar material. A plurality of thermoelectric elements 26, such as peltier elements, are embedded within deck 20 and sealed as discussed below in conjunction with FIGS. 4-6. The thermoelectric deck (including the embedded thermoelectric elements) provide a secondary temperature control mechanism that can be employed to fine tune the temperature of the substrate support surface set by circulating a heat transfer medium through fluid channels 18. For example, the thermoelectric deck and thermoelectric elements 26 allow for the rapid adjustment of temperature (both hot and cold) across the substrate support surface at a very high resolution (e.g., 0.2-0.3 degrees Celsius) that cannot otherwise be achieved by circulation of the fluid heat transfer medium alone.

To further improve and fine tune temperature control, thermoelectric elements 26 can be arranged in multiple zones to independently control the temperature at different locations or regions of the substrate support surface. For example, FIG. 4 shows a substrate support design that includes two independently controlled temperature zones: inner zone 30 and outer zone 32 that surrounds and is concentric with zone 30. In this particular example, zone 30 includes three separate thermoelectric elements 26 while zone 32 includes 12 thermoelectric elements 26. As another example, FIG. 5 shows a substrate support design that includes four independently controlled temperature zones: inner zone 34 and three equally sized outer zones 36, 38, 40 that, together surround inner zone 34. Zone 34 is shown as including three separate thermoelectric elements 26 while each of zones 36, 38, 40 includes four separate thermoelectric elements 26. Embodiments of the invention are not limited to any particular number of temperature zones and are not limited by any particular number of thermoelectric elements per zone. Indeed, some embodiments may include as many as six, ten, twenty or more independently controlled temperature zones. Also shown in each of FIGS. 4 and 5 are three holes 29 that allow the substrate lift pins (not shown) to pass through the substrate support as necessary to contact a substrate. O-rings 35 can be placed around each of holes 29 to seal the holes and prevent the intrusion of gas into undesired areas of thermoelectric deck 20.

Reference is now made to FIG. 6, which is a simplified cross-sectional view of portion A of the substrate support 10 shown in FIG. 3. Each thermoelectric chip 26 embedded within the substrate support is positioned within a cavity formed at the bottom of base plate 22 and is operatively coupled to a temperature sensor 44, such as a resistive thermal device (RTD). Temperature sensor 44 is positioned as close to the upper surface of the base plate 22 as practical to ensure accurate temperature measurements (e.g., 50 mils from the upper surface in one embodiment). In some embodiments, a single temperature sensor 44 may be coupled to multiple thermoelectric chips 26. Additionally, the thermal electric chip 26 is sandwiched between thin top and bottom layers 46 and 48 of a thermal interface material (TIM), such as a thermally conductive but electrically insulative silicon pad. In some embodiments, layers 46, 48 are each between 10-20 mils thick.

Each thermoelectric elements 26 can either heat or cool the substrate support surface in response to temperature measurements received from its associated temperature sensor 44. Whether a particular thermoelectric element 26 is used to heat or cool the substrate surface depends on the voltage supplied to the thermoelectric element. For example, the thermoelectric elements can be arranged to act as a heater in response to a positive DV voltage and a cooler in response to a negative DC voltage where the amount of heating or cooling depends on the magnitude of current. Thermoelectric elements in the same zone are operatively coupled together to heat or cool the substrate support similarly in the zone. A controller (not shown) receives input from temperature sensors 44 and provides an appropriate current level to thermoelectric elements 26 as necessary to provide a desired amount of heating or cooling in each zone. Control and signal wires between the controller and thermoelectric elements and temperature sensors can be routed through a channel 25 that extends through pedestal 16 including stem 21 as shown in FIG. 3.

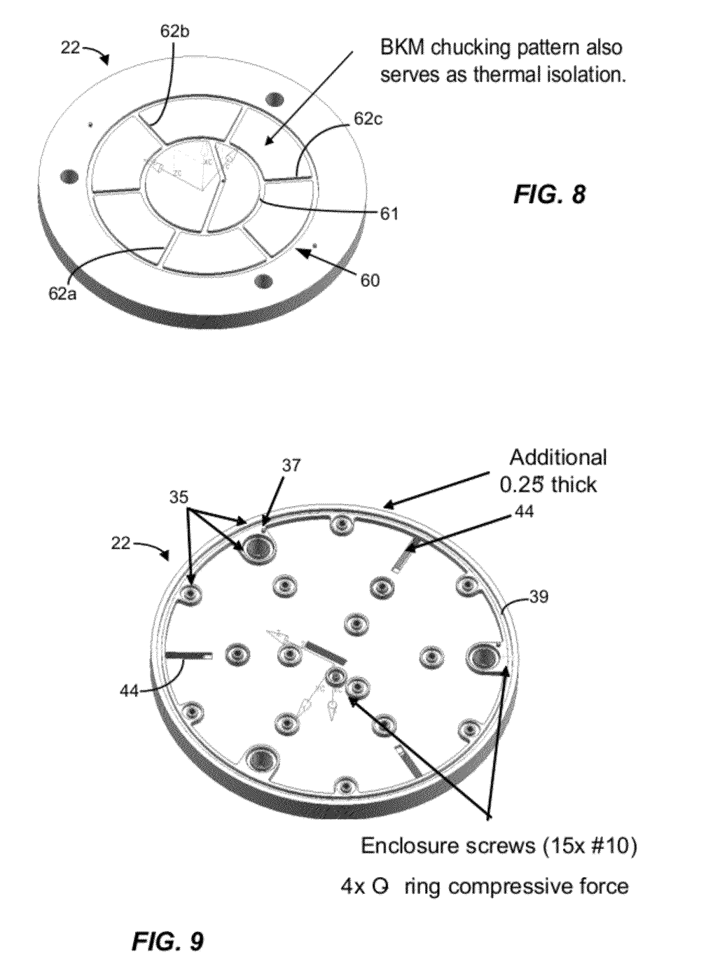

FIG. 7 is a simplified perspective view of one embodiment of deck cover 24 shown in FIG. 3, while FIGS. 8 and 9 are simplified top and bottom perspective views, respectively, of thermoelectric deck base 22 shown in FIG. 3. Deck cover 24 and deck base 22 can be bolted to pedestal 16 thereby allowing thermoelectric deck 20 to be detached from pedestal 20 and replaced if necessary. In one particular embodiment 21 bolts are used to fully secure thermoelectric base 20 to the pedestal and a peripheral O-ring sits in a circular channel 39 that is situated near and parallel to an outer periphery of the thermoelectric deck to seal the interior of the deck from gases introduced within the substrate processing chamber. Channel 39 is formed within a raised rim 43 (e.g., 0.25 inches thick) that provides clearance for the placement of thermoelectric elements 26 between deck base 22 and deck cover 24. Alignment pins 37 can be positioned around the periphery of the thermoelectric deck 20 to facilitate proper alignment of deck 22 and base 24.

As shown in FIG. 8, grooves 60 present at the upper surface of base 22 provide a channel for the flow of purge gas and a vacuum chuck and are fluidly coupled to a vacuum line that runs through stem 21. In one embodiment, the chucking pattern formed by grooves 60 can be aligned to the independently controlled temperature zones, such as zones 30 and 32. For example, in two temperature control zone embodiment shown in FIG. 4, circular groove 61 can be located at a position that aligns with the interface of zone 30 and zone 32. Similarly, in the four temperature control zone embodiments shown in FIG. 5, circular groove 61 can be located at a position that aligns with the interface of zone 34 and the surrounding three zones 36, 38, 40. Similarly, grooves 62a, 62b and 62c can be located to align with the interface between zones 36 and 38 (groove 62a), zones 38 and 40 (groove 62b) and zones 40 and 36 (groove 62c).

The substrate support according to the present invention can be beneficially used to support and control the temperature of a substrate during a variety of different substrate processing operations including thin film deposition and etching operations, among others. One particular process that the present invention is well suited for is a SiConi™ etch. A SiConi etch is a remote plasma assisted dry etch process which involves the simultaneous exposure of a substrate to H₂, NF₃ and NH₃ plasma by-products. Remote plasma excitation of the hydrogen and fluorine species allows plasma-damage-free substrate processing. The SiConi™ etch is largely conformal and selective towards silicon oxide layers but does not readily etch silicon regardless of whether the silicon is amorphous, crystalline or polycrystalline. The selectivity provides advantages for applications such as shallow trench isolation (STI) and inter-layer dielectric (ILD) recess formation.

The SiConi etch is sensitive to temperature variations. Local cooling and/or heating can be used during a SiConi etch process to modify film thickness. Due to the high degree of temperature control embodiments of the present invention provide, in terms of both response time to temperature changes and resolution, the substrate support of the present invention can advantageously be used to more precisely control the thickness of the final film processed in a SiConi etch (or other temperature sensitive film processing operation) across the surface of the wafer.

Having fully described several embodiments of the present invention, other equivalent or alternative apparatuses and methods of controlling the temperature of a substrate according to the present invention will be apparent to those skilled in the art. These alternatives and equivalents are intended to be included within the scope of the present invention.

What is claimed is:

1. A substrate support comprising:
a top ceramic plate providing a substrate support surface for supporting a substrate during substrate processing;
an substrate pedestal having fluid channels formed therein;
a thermoelectric deck sandwiched between the top ceramic plate and substrate pedestal, the thermoelectric deck having a plurality of thermoelectric elements embedded therein that can either heat or cool the substrate support surface.

2. The substrate support of claim 1 wherein the thermoelectric elements are arranged and operatively coupled to provide independent temperature control in at least two different zones of the substrate support surface with each zone having at least one temperature sensor associated with it.

3. The substrate support of claim 2 wherein at least two different zones includes a first inner zone and a second zone that surrounds and is concentric with the inner zone.

4. The substrate support of claim 1 wherein the thermoelectric elements are operatively coupled to provide independent temperature control in at least four different zones of the substrate support surface with each zone having at least one temperature sensor associated with it.

5. The substrate support of claim 4 wherein the at least four different zones include a first inner zone and a plurality of equally sized outer zone that, when taken together, surround and are concentric with the inner zone.

6. The substrate support of claim 1 further comprising a heat exchanger operatively coupled to the substrate pedestal to circulate a cooling liquid through the coolant channels in the pedestal.

7. The substrate support of claim 1 wherein the thermoelectric elements comprise peltier elements.

8. The substrate support of claim 1 wherein the thermoelectric elements are sandwiched between upper and lower layers of a thermal interface material.

9. The substrate support of claim 6 wherein the thermal interface material comprises a silicon pad.

10. The substrate support of claim 8 wherein the upper and lower layers of thermal interface material are each between 10-20 mils thick.

11. The substrate support of claim 8 wherein the thermal interface material is a thermally conductive, electrically insulative material.

12. The substrate support of claim 2 wherein the thermoelectric deck comprises a base plate positioned above and attached to a thermoelectric deck cover.

13. The substrate support of claim 12 wherein the base plate and thermoelectric deck cover are each made from an aluminum alloy.

14. The substrate support of claim 12 wherein the aluminum base plate comprises grooves formed at its upper surface in a pattern that improves thermal isolation of the at least two independently controlled temperature zones.

15. A substrate support comprising:
a top ceramic plate providing a substrate support surface for supporting a substrate during substrate processing;
an substrate pedestal having fluid channels formed therein, the fluid channels adapted to circulate a heat transfer fluid through the pedestal as a primary mechanism to control a temperature of the substrate support surface;
a thermoelectric deck sandwiched between the top ceramic plate and substrate pedestal, the thermoelectric deck having a base plate, a deck cover, and a plurality of thermoelectric elements positioned between the base plate and the deck cover arranged in at least two independently controlled temperature zones with each independently controlled temperature zone including a temperature sensor, wherein in each independently controlled temperature zone the thermoelectric deck can either heat or cool the substrate support surface in that zone in response to readings from temperature sensor associated with the zone thereby providing a secondary mechanism to adjust the temperature of the substrate support surface set primarily by circulating a heat transfer medium through the fluid channels.

16. The substrate support set forth in claim 15 wherein the thermoelectric deck allows for the adjustment of temperature across the substrate support surface at a resolution and rate that cannot otherwise be achieved by circulation of the fluid heat transfer medium alone.

17. The substrate support of claim 16 wherein the thermoelectric elements are arranged and operatively coupled to provide independent temperature control in at least two different zones of the substrate support surface including a first inner zone and a second zone that surrounds and is concentric with the inner zone.

18. The substrate support of claim 16 wherein the thermoelectric elements are operatively coupled to provide independent temperature control in at least four different zones of the substrate support surface including a first inner zone and a plurality of equally sized outer zone that, when taken together, surround and are concentric with the inner zone.
